(19) United States
(12) Patent Application Publication
(10) Pub. No.: US 2014/0010510 A1
(43) Pub. Date: Jan. 9, 2014

(54) OPTICAL FIBER CONNECTIVITY MANAGEMENT SYSTEM

(71) Applicant: Stephen R. Blackard, Garland, TX (US)

(72) Inventor: Stephen R. Blackard, Garland, TX (US)

(21) Appl. No.: 13/541,419

(22) Filed: Jul. 3, 2012

(51) Int. Cl. G02B 6/44

(52) U.S. Cl. CPC G02B 6/4453
USPC 385/135

(57) ABSTRACT

A modular fiber connectivity management system comprises a 1-RU bracket having a front panel defining four openings adapted to receive up to four cassettes, and one to four cassettes having front and rear mating interfaces adapted for interfacing with cable connectors and adapted for mounting to the front panel of the bracket, each front mating interface of a cassette adapted to interface with up to 36 fiber connectors of a first type for a total of up to 144 fiber connectors, and each rear mating interface of a cassette adapted to interface with fiber connectors of a second type.

### RELATED APPLICATION

This patent application is related to co-pending design patent application Ser. No. ______, entitled “Optical Fiber Management Bracket” filed on Jul. 3, 2012, and to design patent application Ser. No. ______, entitled “Optical Fiber Management Cassette” also filed on Jul. 3, 2012.

### FIELD

The present disclosure relates the field of optical communications, and more particularly to an optical fiber connectivity management system.

### BACKGROUND

Current computing, communications, and data management requirements are steadily driving the need for density. Computing and data management companies that service and support businesses, factories, and residences typically house the computer servers and other electronics and computing components in special facilities equipped with racks or cabinets populated with connection sites for optical fibers and cables. These racks or cabinets further include fiber optic devices, such as attenuators, connectors, adapters, switches, multiplexers, splitters, combiners, splices, etc. to connect and route the signals transmitted in the optical fibers and cables. Incoming and outgoing fibers typically enter and exit the various rack units from the front and/or the rear of the racks. Typically, each rack or cabinet houses a number of brackets, each of which in turn houses a number of optical cassettes. Specialized optical connectors are mounted within the cassettes to enable connection and cross-connection with optical fibers and optical fiber cables.

### SUMMARY

A modular fiber connectivity management system comprises a 1-RU bracket having a front panel defining four openings adapted to receive up to four cassettes, and one to four cassettes having front and rear mating interfaces adapted for interfacing with cable connectors and adapted for mounting to the front panel of the bracket, each front mating interface of a cassette adapted to interface with up to 36 fiber connectors of a first type for a total of up to 144 fiber connectors, and each rear mating interface of a cassette adapted to interface with fiber connectors of a second type.

A modular cable connectivity management system comprises an high-density 1-RU bracket having a front panel and a bottom panel, the front panel defining four openings each adapted to receive one cassette, and one to four cassettes each having front and rear mating interfaces adapted for interfacing with cable connectors and adapted for mounting to the front panel of the bracket, each front mating interface of a cassette having adaptors of a first type, and each rear mating interface of a cassette having adaptors of a second type.

An high-density modular fiber cassette comprises a front mating interface adapted for interfacing with cable connectors of a first type connected to up to 36 fiber cables, and a rear mating interface adapted for interfacing with cable connectors of a second type.

### BRIEF DESCRIPTION OF THE DRAWINGS

FIG. 1 is a perspective view of an exemplary embodiment of an optical fiber connectivity management system 10 according to the present disclosure;

FIG. 2 a front elevational view of an exemplary embodiment of an optical fiber connectivity management system 10 according to the present disclosure;

FIG. 3 is a top view of an exemplary embodiment of an optical fiber connectivity management system 10 according to the present disclosure;

FIG. 4 is an exploded perspective view of an exemplary embodiment of an optical fiber connectivity management system 10 according to the present disclosure;

FIGS. 5 and 6 are perspective views of an exemplary embodiment of an optical fiber bracket according to the present disclosure;

FIG. 7 is a front elevational view of an exemplary embodiment of an optical fiber bracket according to the present disclosure;

FIG. 8 is a back elevational view of an exemplary embodiment of an optical fiber bracket according to the present disclosure;

FIG. 9 is a bottom elevational view of an exemplary embodiment of an optical fiber bracket according to the present disclosure;

FIG. 10 is a side elevational view of an exemplary embodiment of an optical fiber bracket according to the present disclosure;

FIG. 11 is a perspective view of an exemplary embodiment of an optical fiber cassette according to the present disclosure;

FIG. 12 is a front elevational view of an exemplary embodiment of an optical fiber cassette according to the present disclosure;

FIG. 13 is a side elevational view of an exemplary embodiment of an optical fiber cassette according to the present disclosure; and

FIG. 14 is a top view of an exemplary embodiment of an optical fiber cassette according to the present disclosure.

### DETAILED DESCRIPTION

Optical fiber connection management systems are typically known as outside plant distribution cabinets, distribution frames, or patch panels that are used for interconnection or cross-connection of optical fibers and cables. Typically optical fiber cables that comprise multiple optical fibers are connected to a panel in a cabinet, frame or panel to connect to individual fibers that provide service to homes or businesses, for example. The optical fiber connectivity management system described herein provides a compact modular and high-density system that can be easily configured for different applications and needs.

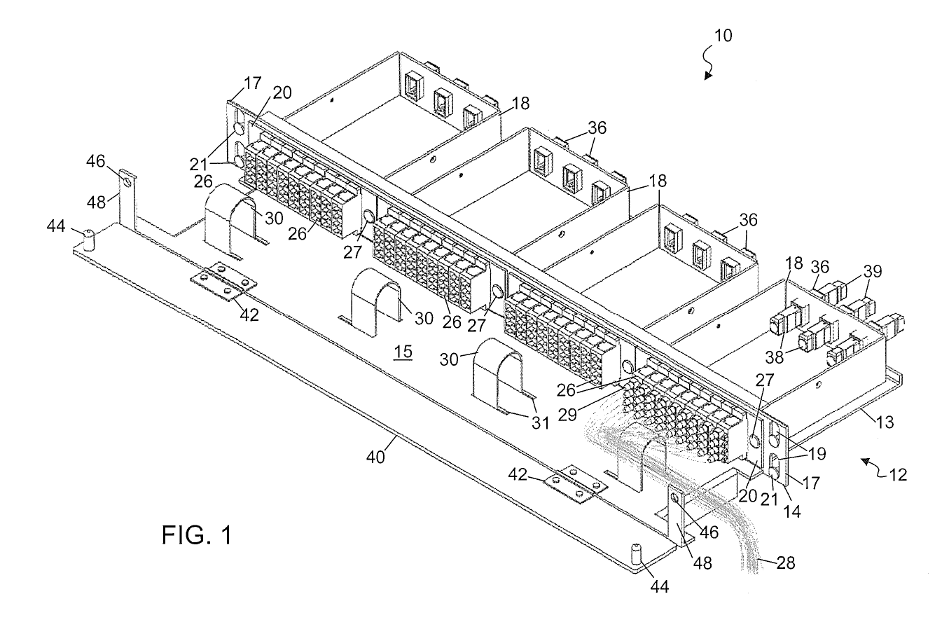

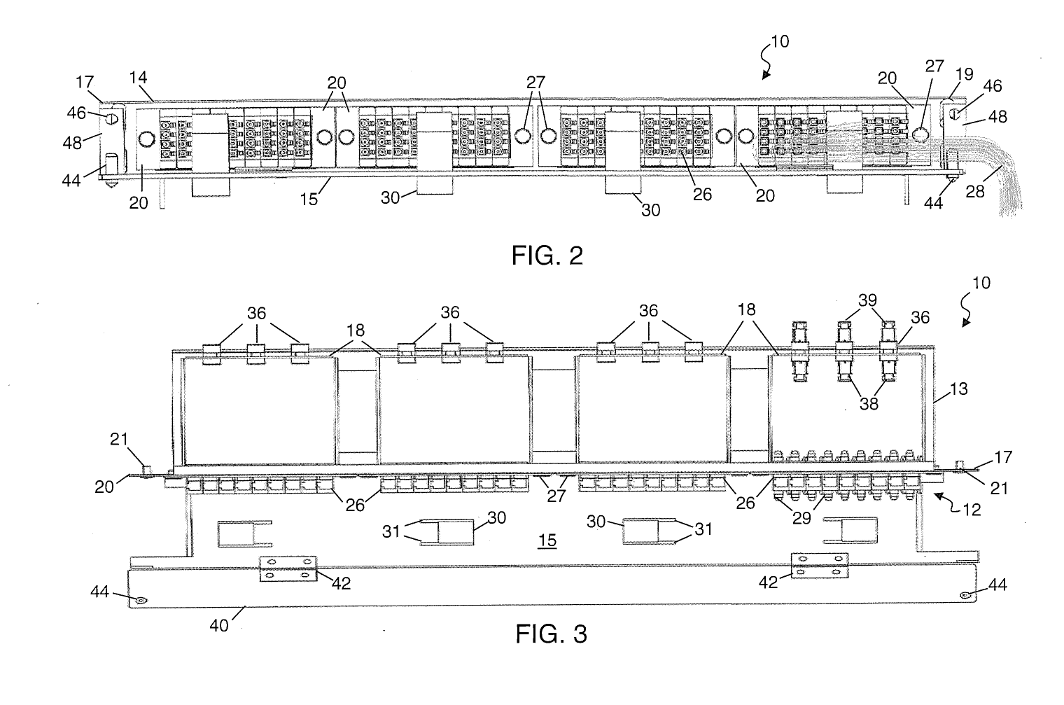

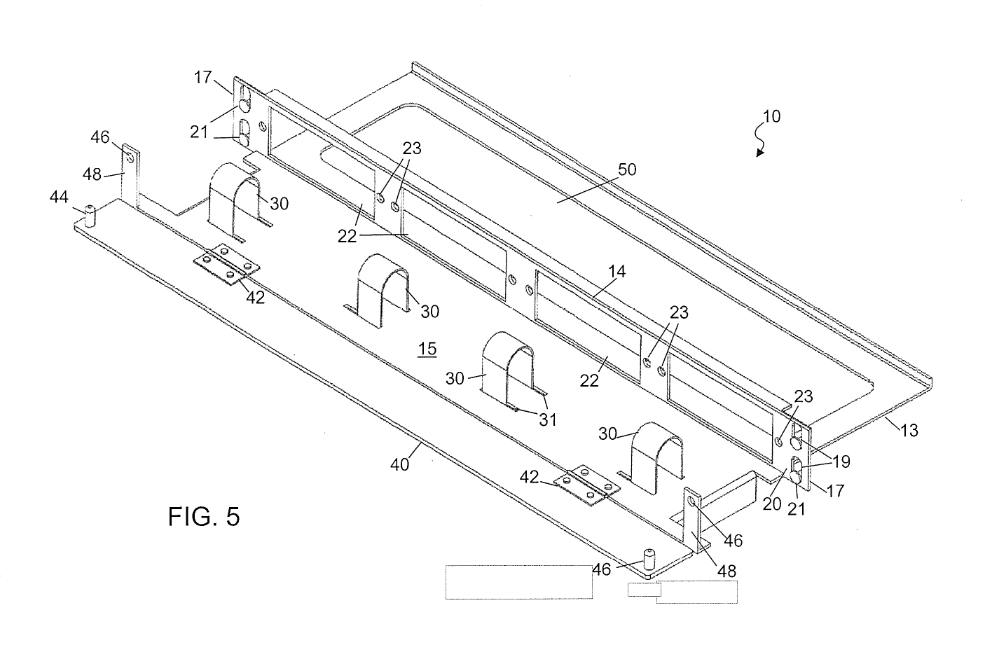

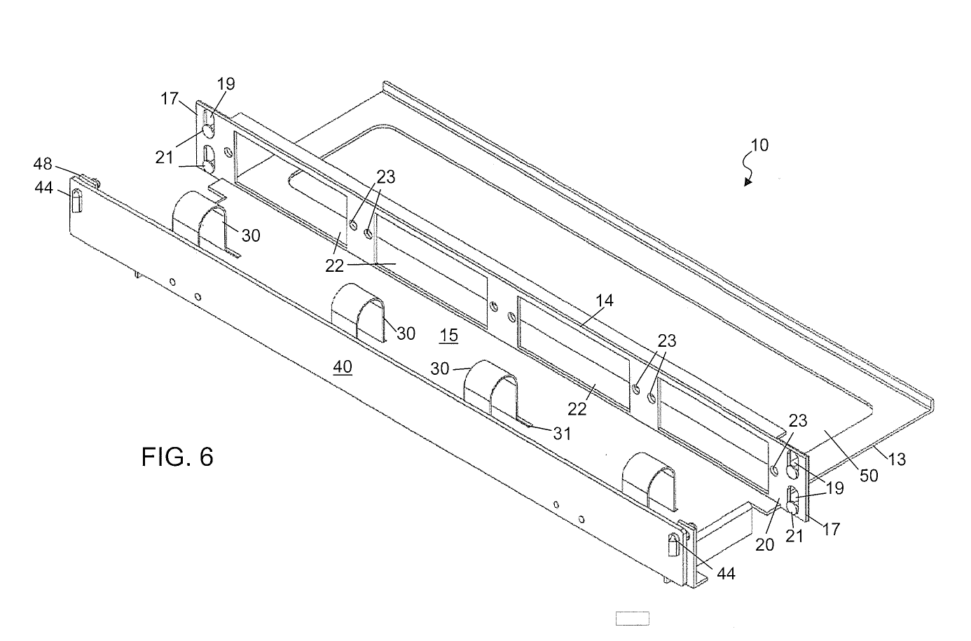

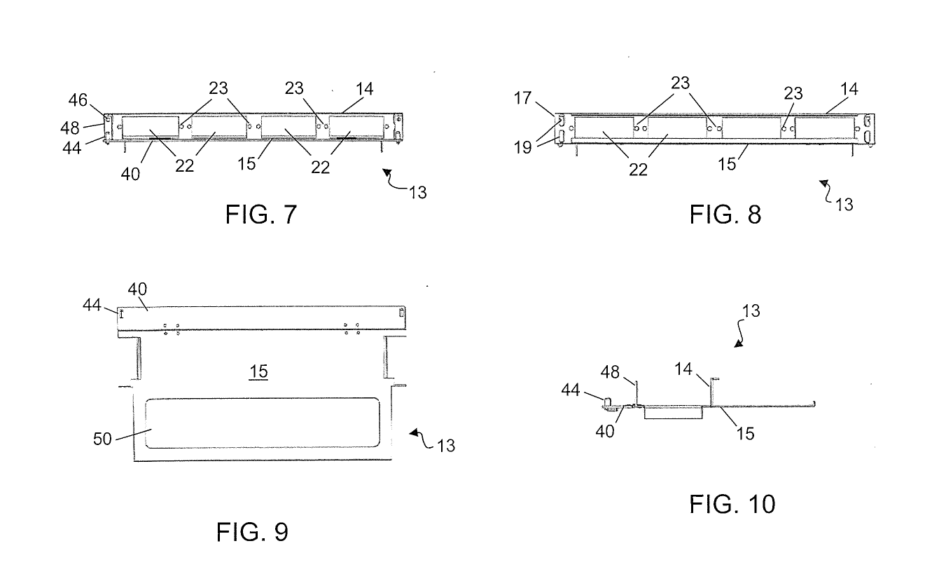

FIG. 1 is a perspective view of an exemplary embodiment of an optical fiber connectivity management system 10 designed for dense fiber applications according to the present disclosure. Refer also to FIGS. 2-4 for a front elevational view, top view, and exploded perspective view, respectively, of the optical fiber connectivity management system 10. System 10 includes a bracket assembly 12 having a bracket 13 with a front panel 14 having a plurality of openings 16 adapted to receive a plurality of cassettes or modules 18. In the embodiment shown, the bracket assembly 12 can accommodate one, two, three, or four cassettes 18. Preferably, the bracket assembly 12 is compatible with standard industry form factors. FIGS. 5 and 6 further provide perspective views of an exemplary embodiment of the bracket assembly 12 according to the present disclosure. Further, FIGS. 7-10 are various views of an exemplary embodiment of the optical fiber bracket 13 according to the present disclosure. The front panel 14 is generally vertically oriented with respect to the generally planar horizontally-oriented bottom panel 15 of the bracket assembly 12. The front panel 14 includes two mounting extensions 17 with defined openings 19 adapted to receive mounting fasteners 21, such as bolts, screws, etc. The mounting extensions 17 of the front panel 14 are adapted to interface with or mount to structural members (not shown) of an equipment rack or cabinet.

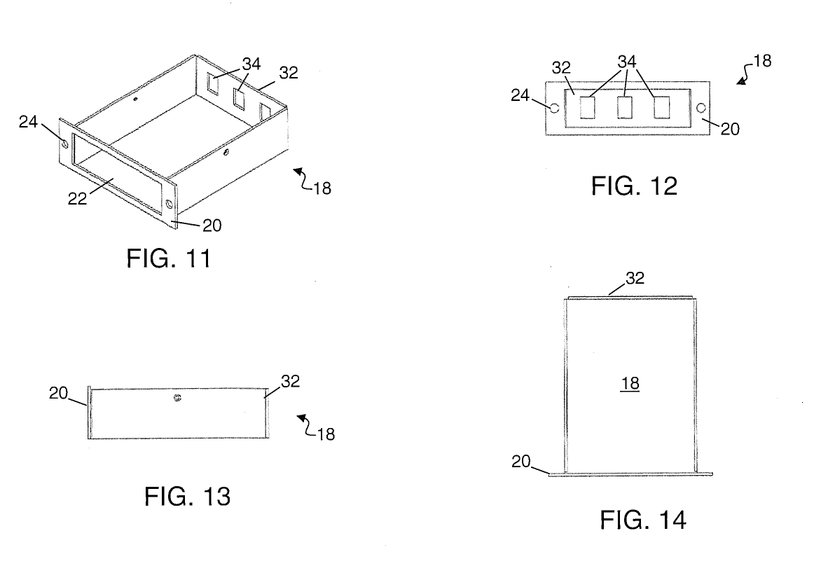

As best seen in FIGS. 11-14, showing perspective, front, side, and top views, each cassette 18 includes a front mating surface or mounting tabs 20 defined around an opening 22 which generally coincides with the openings 16 in the front panel 14 of the bracket 13. The front mating surface 20 of the cassette 18 is adapted to interface with and fasten to the front panel 14 of the bracket 13. Through holes 23 in the front panel 14 of the bracket 13 and through holes 24 in the front mating surface 20 of the cassette 18 coincide to jointly receive fasteners 27 such as bolts, screws, and the like to detachably secure the cassettes 18 to the front panel 14.

The cassette opening 22 is adapted to receive a plurality of receptacles 26 such as quad LC adapters operable to receive optical fibers 28 fitted with fiber connectors, such as LC connectors (not shown). In the exemplary embodiment shown, up to nine quad LC adapters 26 are accommodated within the opening 22 of each cassette 18. Accordingly, with four cassettes 18, up to a total of 144 LC adapters 26 (or 144 LC ports) may be installed and organized in a single 1 RU (rack-unit) height of the bracket assembly 12. The array of receptacles 26 defines the front mating connection of the system 10. It should be noted that the receptacles and the connectors that they accept may be of any suitable number, configuration, and type. For example, the fiber connectors may be of any suitable type including LC, SC, ST, MT-RJ, MU, ESCON, and the like.

Constructed in this manner, the system 10 is adapted to receive or accept at least 144 optical fibers 28 (or other types of cabling) via appropriate connectors 29 at its front mating connection or front panel 14. To keep these cables neatly organized and restrained, a number of fasteners 30 may be used to fasten or tie them together. For example, hook-and-loop fastener straps 30 may be used for this purpose. The fastener straps 30 may be adhered (glued, tacked, bolted, etc.) to the bottom panel 15 of the bracket 13 or looped through a number of openings or slots 31 therein. Other types of fasteners such as cable ties, twist-ties, and the like may be used.

Each cassette 18 further comprises a rear panel 32 that defines a plurality of openings 34 adapted to accommodate adapters 36 such as bulkhead adapters configured to receive and couple male and female connectors 38 and 39 of the MTP (Mechanical Transfer Pull) type, for example. As shown in the embodiment illustrated in the drawing figures, the system 10 equipped with four cassettes 18 is operable to connect to a total of up to 12 MTP trunk cables. It should be noted that the cassettes 18 may be configured to accept any suitable number, configuration, and type of connectors and adapters depending on the application. For example, the cassette may comprise MPO (Multi-fiber Push-On) connectors and the like.

The bracket assembly 12 further includes a front door 40 hinged to the bottom panel 15. A plurality of rotatable fasteners such as hinges 42 and 43 may be used to fasten the front door 40 to the bracket 13, as shown in FIG. 6. When the front door 40 is in the vertical or closed position, the pegs 44 on the front door 40 mate and engage the openings 46 in the vertical tabs 48 of the bracket assembly 12. In a preferred embodiment, the pegs 44 may be of a particular shape to easily insert into the openings 46 to close the front door 40, and may expand to prevent inadvertent opening of the front door 40. Alternatively, the pegs 44 may incorporate stops, latch, or another means of releasably fastening to the vertical tabs 48. Other suitable methods of fastening the front door 40 or otherwise maintaining its upright orientation may be used. The front door 40 is preferably at least partially constructed of a transparent or opaque material to permit easy visual inspection of the bracket assembly 12 and optical cables 28 therein when the bracket assembly is installed in a rack (not shown).

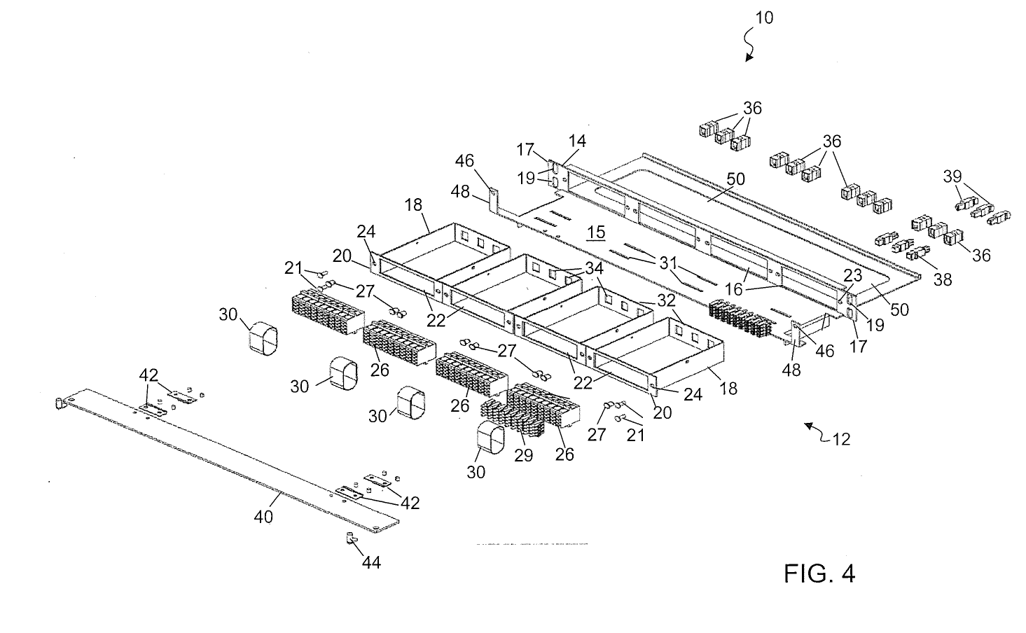

As best seen in the perspective and top views in FIGS. 4-6 and FIG. 9, the generally planar bottom panel 15 of the bracket 13 may define therein a generally rectangular opening 50. Forming an opening 50 in the bottom panel 15 greatly reduces the overall weight and bulk of the bracket 13, and yet does not alter its structural integrity.

The modularity and adaptability of installing up to four high-density cassettes in a single 1 RU (rack-unit) height according to application and/or need gives the system flexible and easy configurability. Although the disclosed bracket is of a 1 RU height, the cassettes disclosed herein may be installed in a compact manner in a multiple-RU bracket. Potential application areas for the fiber connectivity management system described herein include: telecommunication closets, data centers, customer premise, LAN/WAN networks, central office/headends, hubs/cabinets/remote terminals, FTTH/FTTB networks, and the like. Although the descriptions herein emphasizes the management of optical fibers and fiber cables, the present disclosure contemplates management of other forms of cables operable to transmit signals of other types.

The features of the present invention which are believed to be novel are set forth below with particularity in the appended claims. However, modifications, variations, and changes to the exemplary embodiments described above will be apparent to those skilled in the art, and the system and method described herein thus encompass such modifications, variations, and changes and are not limited to the specific embodiments described herein.

What is claimed is:

1. A modular fiber connectivity management system comprising:
a 1-RU bracket having a front panel defining four openings adapted to receive up to four cassettes; and
one to four cassettes having front and rear mating interfaces adapted for interfacing with cable connectors and adapted for mounting to the front panel of the bracket, each front mating interface of a cassette adapted to interface with up to 36 fiber connectors of a first type for a total of up to 144 fiber connectors, and each rear mating interface of a cassette adapted to interface with fiber connectors of a second type.

2. The system of claim 1, further comprising a hinged door rotatably coupled to the bracket and disposed in front of the front panel.

3. The system of claim 2, wherein the hinged door is constructed at least partially of a transparent/opaque material.

4. The system of claim 1, further comprising a plurality of fasteners fastened to a bottom panel of the bracket disposed in front of the front panel for restraining up to 144 fiber cables coupled to the 144 fiber connectors.

5. The system of claim 4, wherein the plurality of fasteners comprise hook-and-loop straps.

6. The system of claim 1, wherein the connectors of a first type comprise LC connectors.

7. The system of claim 1, wherein the connectors of a second type comprise MTP connectors.

8. The system of claim 1, wherein the connectors of a first type is selected from a group consisting of LC, SC, ST, MTRJ, MU, and ESCON connectors.

9. The system of claim 1, wherein the connectors of a second type is selected from a group consisting of MTP and MPO connectors.

10. The system of claim 1, wherein each cassette is operable to accommodate up to nine quad LC adaptors.

11. A modular cable connectivity management system comprising:
an high-density 1-RU bracket having a front panel and a bottom panel, the front panel defining four openings each adapted to receive one cassette;
one to four cassettes each having front and rear mating interfaces adapted for interfacing with cable connectors and adapted for mounting to the front panel of the bracket, each front mating interface of a cassette having adaptors of a first type, and each rear mating interface of a cassette having adaptors of a second type.

12. The system of claim 11, further comprising a hinged door constructed at least partially of a transparent/opaque material rotatably coupled to the bracket and disposed in front of the front panel.

13. The system of claim 11, wherein the front mating interface of each cassette is adaptable to accommodate up to 36 fiber connectors, for a total of up to 144 fiber connectors operable to couple to up to 144 fiber cables in the bracket.

14. The system of claim 13, further comprising a plurality of fasteners fastened to the bottom panel of the bracket for restraining the up to 144 fiber cables.

15. The system of claim 14, wherein the plurality of fasteners comprise hook-and-loop straps.

16. The system of claim 11, wherein the connectors of a first type comprise LC connectors.

17. The system of claim 11, wherein the connectors of a second type comprise MTP connectors.

18. The system of claim 11, wherein the connectors of a first type is selected from a group consisting of LC, SC, ST, MTRJ, MU, and ESCON connectors.

19. The system of claim 11, wherein the connectors of a second type is selected from a group consisting of MTP and MPO connectors.

20. The system of claim 11, further comprising a rack adapted to accommodate a plurality of brackets mounted therein.

21. An high-density modular fiber cassette comprising:
a front mating interface adapted for interfacing with cable connectors of a first type connected to up to 36 fiber cables; and
a rear mating interface adapted for interfacing with cable connectors of a second type.

22. The modular fiber cassette of claim 21, further being adapted for mounting into a bracket assembly.

23. The modular fiber cassette of claim 21, further being adapted for mounting into a bracket assembly with at least three other modular fiber cassettes to couple to up to a total of 144 fiber cables.

24. The modular fiber cassette of claim 21, wherein the connectors of a first type is selected from a group consisting of LC, SC, ST, MTRJ, MU, and ESCON connectors.

25. The modular fiber cassette of claim 21, wherein the connectors of a second type is selected from a group consisting of MTP and MPO connectors.

26. The modular fiber cassette of claim 21, wherein each cassette is operable to accommodate up to nine quad LC adaptors.

27. The modular fiber cassette of claim 21, further being adapted for mounting into a bracket assembly with more than three other modular fiber cassettes to couple to more than 144 fiber cables.
